(19) United States
(12) Patent Application Publication
(10) Pub. No.: US 2016/0252240 A1
(43) Pub. Date: Sep. 1, 2016

(54) LED LIGHTING APPARATUS

(71) Applicant: ICEPIPE CORPORATION, Seoul (KR)

(72) Inventor: Dong Ju LEE, Gyeonggi-do (KR)

(73) Assignee: ICEPIPE CORPORATION, Seoul (KR)

(21) Appl. No.: 14/762,444

(22) PCT Filed: Nov. 3, 2014
(86) PCT No.: PCT/KR2014/010454

§ 371 Date: Jul. 21, 2015

(30) Foreign Application Priority Data
Jun. 2, 2014 (KR) 10-2014-0067124

(51) Int. Cl. F21V 29/51; F21V 17/10; F21V 29/67; F21K 99/00; F21V 15/01; F21V 29/83; F21V 23/02

(52) U.S. Cl. CPC F21V 29/51; F21V 29/83; F21V 17/101; F21V 23/02; F21K 9/13; F21V 15/01; F21V 29/67; F21Y 2101/02

(57) ABSTRACT

Provided is a light emitting diode (LED) lighting apparatus. The LED lighting apparatus includes a printed circuit board (PCB) having a plate-shaped structure with an opened center portion; an LED chip mounted on a surface of the PCB; a ventilation unit including an end portion having an opening, other end portion coupled to the opened center portion of the PCB, and an air flowing passage connecting the opening and the opened center region of the PCB to each other; a heat sink coupled to the other surface of the PCB so as to cool down heat generated from the LED chip; a cover member including an air flowing hole corresponding to a location of the opening and covering partially the PCB, the LED chip, the ventilation unit, and the heat sink; and a base including a ventilation hole that is capable of connecting to the air flowing path and coupled to the cover ember so as to cover remaining parts of the PCB, the LED chip, the ventilation unit, and the heat sink.

### FIELD OF THE INVENTIVE CONCEPT

The inventive concept relates to a light emitting diode (LED) lighting apparatus.

### DESCRIPTION OF THE RELATED ART

When a light emitting diode (LED) lighting apparatus operates, an LED thereof generates much heat. In general, if the LED lighting apparatus is overheated, an operating error may occur or the LED lighting apparatus may be damaged. Thus, a heat dissipation structure for preventing overheating is essentially necessary. Also, an electric power apparatus supplying electric power to the LED generates much heat, and if the electric power apparatus is overheated, the lifespan thereof may be reduced.

An LED lighting apparatus according to the prior art may include an LED package on which LED chips are mounted, a metal printed circuit board (PCB) having the LED package mounted on an upper surface thereof, and a heat sink provided on a lower surface of the metal PCB.

According to the LED lighting apparatus of the prior art, heat generated from the LED chip is transferred to the heat sink via a package substrate of the LED package and the metal PCB. However, according to the prior art, a plurality of elements exist on a heat transferring path, and thus, the thermal resistance of all of the plurality of elements affects the heat and the heat generated from the LED chip may not be effectively disspated.

Also, the LED lighting apparatus has a complicated structure, is manufactured through a plurality of processes, and is very inefficient in terms of manufacturing costs and time.

### RELATED ART DOCUMENTS

Patent Document

Korean Laid-open Utility Model No. 20-2009-0046370 (May 11, 2009)

### DETAILED DESCRIPTION OF THE INVENTIVE CONCEPT

### Technical Problem

The inventive concept provides a light emitting diode (LED) lighting apparatus having a simplified structure and excellent heat dissipating performance.

### Technical Solution

According to an aspect of the present inventive concept, there is provided a light emitting diode (LED) lighting apparatus, including: a printed circuit board (PCB) having a plate-shaped structure with an opened center portion; an LED chip mounted on a surface of the PCB; a ventilation unit including an end portion having an opening, other end portion coupled to the opened center portion of the PCB, and an air flowing passage connecting the opening and the opened center region of the PCB to each other; a heat sink coupled to other surface of the PCB so as to cool down heat generated from the LED chip; a cover member including an air flowing hole corresponding to a location of the opening and covering partially the PCB, the LED chip, the ventilation unit, and the heat sink; and a base including a ventilation hole that is capable of connecting to the air flowing path and coupled to the cover ember so as to cover remaining parts of the PCB, the LED chip, the ventilation unit, and the heat sink.

Here, the heat sink may include a heat pipe loop of an oscillating capillary tube type, the heat pipe loop being formed as capillary tubes into which a working fluid is injected and comprising a heat absorption unit coupled to the other surface of the PCB to transfer heat and a heat dissipation unit configured to discharge the heat absorbed by the heat absorption unit.

The Led lighting apparatus may further include a power unit for supplying electric power to the LED chip, wherein the heat pipe loop may have a spiral structure and may be disposed in a loop shape so as to form the heat dissipation unit of a radial shape, and the power unit may be inserted in a center region of the heat pipe loop.

A continuous insertion recess corresponding to a shape of the heat absorption unit may be formed in the other surface of the PCB, and the heat pipe loop may be coupled to the PCB by inserting the heat absorption unit in the insertion recess.

The LED lighting apparatus may further include a thermal base having a plate-shaped structure and disposed between the PCB and the heat sink, wherein the thermal base may include intermittent insertion grooves corresponding to the shape of the heat absorption unit in a surface coupled to the heat sink, and the heat pipe loop may be coupled to the thermal base by inserting the heat absorption unit into the insertion grooves.

The LED lighting apparatus may further include a thermal base having a plate-shaped structure and disposed between the PCB and the heat sink, wherein the thermal base may include intermittent through holes penetrating through opposite surfaces thereof to correspond to the shape of the heat absorption unit, and the heat pipe loop may be coupled to the thermal base by inserting the heat absorption unit into the through holes to contact the PCB.

The PCB and the heat pipe loop or the thermal base and the heat pipe loop may be coupled to each other by using a thermal conductive adhesive.

The PCB and the heat pipe loop or the thermal base and the heat pipe loop may be coupled to each other by a soldering method.

In addition, the ventilation unit may include an air circulator configured to accelerate flowing of air induced through the air flowing passage.

### DESCRIPTION OF THE DRAWINGS

FIG. 1 is a perspective view of a light emitting diode (LED) lighting apparatus according to an exemplary embodiment of the inventive concept;

FIG. 2 is a cross-sectional view of the LED lighting apparatus according to the exemplary embodiment of the inventive concept;

FIGS. 3 and 4 are diagrams showing a printed circuit board (PCB), a ventilation unit, and a heat sink in detail in the LED lighting apparatus according to the exemplary embodiment of the inventive concept;

FIG. 5 is a cross-sectional view of an LED lighting apparatus according to another exemplary embodiment of the inventive concept;

FIG. 6 is a diagram showing a PCB, a ventilation unit, a thermal base, and a heat sink in detail in an LED lighting apparatus according to another exemplary embodiment of the inventive concept; and

FIG. 7 is a diagram showing a modified example of a thermal base in an LED lighting apparatus in detail according to another exemplary embodiment of the inventive concept.

### EXPLANATIONS FOR REFERENCE NUMERALS

100: printed circuit board
110: insertion recess
200: LED chip
300: ventilation unit
310: air circulator
400: heat sink
410: heat pipe loop
500: power unit
600: cover member
700: electric connection unit
800: base
900: thermal base
910: insertion groove
920: through hole
1000, 2000: LED lighting apparatus

### MODE OF THE INVENTIVE CONCEPT

As the inventive concept allows for various changes and numerous embodiments, particular embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope of the present inventive concept are encompassed in the present inventive concept. In the description of the present inventive concept, certain detailed explanations of the related art are omitted when it is deemed that they may unnecessarily obscure the essence of the inventive concept.

While such terms as “first,” “second,” etc., may be used to describe various components, such components must not be limited to the above terms. The above terms are used only to distinguish one component from another.

The terms used in the present specification are merely used to describe particular embodiments, and are not intended to limit the present inventive concept. An expression used in the singular encompasses the expression of the plural, unless it has a clearly different meaning in the context. In the present specification, it is to be understood that the terms such as “including”, “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Hereinafter, one or more exemplary embodiments of a light emitting diode (LED) lighting apparatus according to the inventive concept will be described in more detail with reference to accompanying drawings. When describing the embodiments with reference to accompanying drawings, like reference numerals in the drawings denote like elements, and thus their description will be omitted.

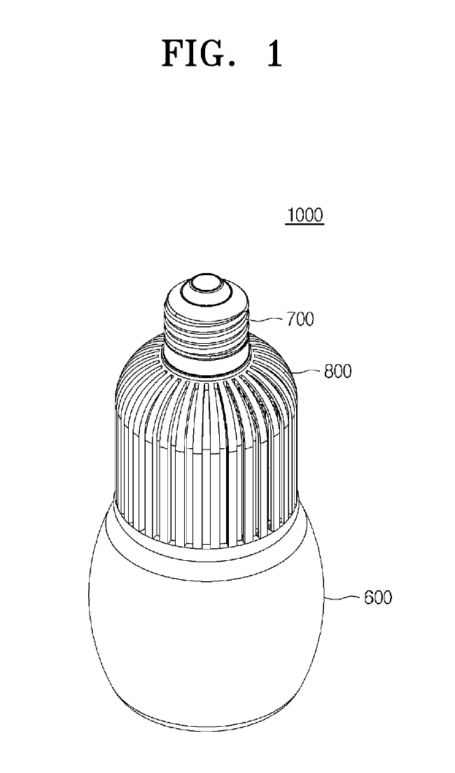

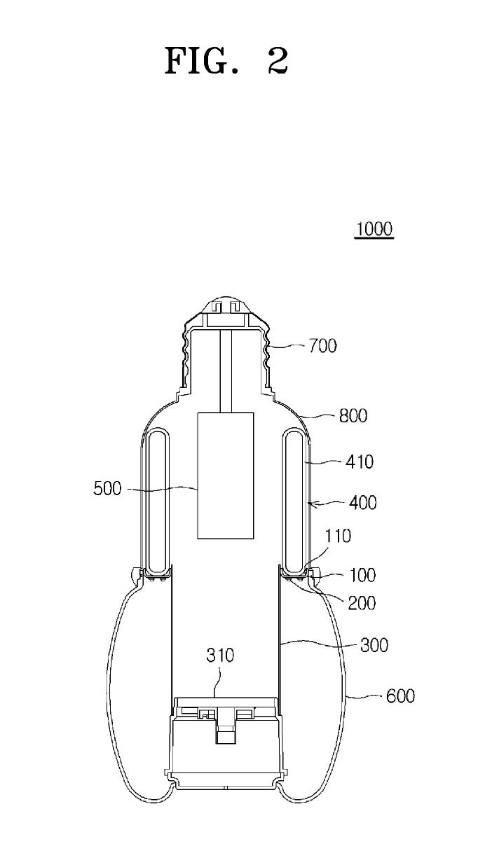

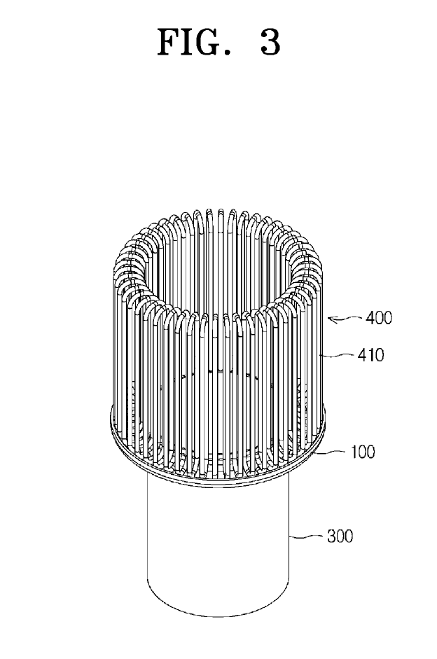

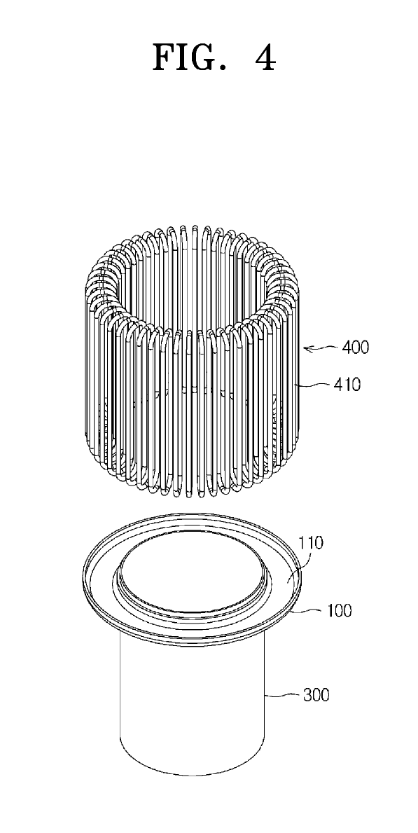

FIG. 1 is a perspective view of an LED lighting apparatus according to an exemplary embodiment of the inventive concept, FIG. 2 is a cross-sectional view of the LED lighting apparatus according to the exemplary embodiment of the inventive concept, and FIGS. 3 and 4 are diagrams showing in detail a printed circuit board (PCB), a ventilation unit, and a heat sink in the LED lighting apparatus according to the exemplary embodiment of the inventive concept.

As shown in FIGS. 1 to 4, the LED lighting apparatus 1000 according to the present exemplary embodiment of the inventive concept includes the PCB 100, an LED chip 200, the ventilation unit 300, and the heat sink 400. The LED lighting apparatus 1000 may further include a power unit 500.

The PCB 100 has a plate type structure having an opened center portion. As shown in FIGS. 2 to 4, the LED chip 200 may be mounted on a surface of the PCB 100, and the heat sink 400 may be coupled to the other surface of the PCB 100. The PCB 100 may be formed of an insulating layer such as FR-4, and circuit patterns formed on the insulating layer.

The LED chip 200 is mounted on the surface of the PCB 100, and may emit light by using electric energy. In this case, the LED chip 200 may be an LED package including a package substrate and an LED mounted on the package substrate to be packaged. That is, a detailed structure of the LED chip 200, the number of the LED chip 200, and arrangement of the LED chip 200 may be selected according to necessity.

The ventilation unit 300 has an end portion in which an opening is formed and the other end portion coupled to a center portion of the PCB 100, and has an air flowing passage connecting the opening and the center portion of the PCB 100 to each other therein. As shown in FIGS. 2 and 3, the ventilation unit 300 may have a pipe structure.

Air induced into the opening through the ventilation unit 300 may be discharged out of the center portion of the PCB 100, which is opened, via the air flowing passage, so as to form flow of the air.

In this case, since the LED chip 200 is disposed on an outer portion of the ventilation unit 300 as shown in FIGS. 2 to 4, heat may be dissipated to some degree through the air that flows through the air flowing passage.

The heat sink 400 is coupled to the other surface of the PCB 100 in order to cool the heat generated from the LED chip 200 down, and may dissipate the heat transferred from the LED chip 200 via the PCB 100 by using heat conduction or heat convection.

Meanwhile, the heat sink 400 is not limited to the structure shown in FIGS. 2 to 4, but a heat dissipating substance that is obtained by forming thermal conductive metal such as copper as a wire or a coil may be used, that is, the heat sink 400 may be modified variously according to necessity.

In this case, the heat generated from the LED chip 200 is dissipated through the heat sink 400 that is directly coupled to the PCB 100 without passing through a complicated heat transfer path, and thus, heat dissipation efficiency may be improved.

Also, when the heat dissipation is performed through the heat sink 400, the air induced to the ventilation unit 300 may circulate while flowing toward the heat sink 400 after passing through the center portion of the PCB 100, and thus, the heat dissipation efficiency may be further improved.

As described above, in the LED lighting apparatus 1000 according to the present exemplary embodiment, the LED chip 200 is mounted on the surface of the PCB 100 and the heat sink 400 is coupled to the other surface of the PCB 100, and the air may flow through the ventilation unit 300. Thus, the LED lighting apparatus 1000 may have excellent heat dissipation performance with a simple structure.

In the LED lighting apparatus 1000 of the present exemplary embodiment, the heat sink 400 may include a heat pipe loop 410 of a oscillating capillary tube type, that is, the heat pipe loop 410 is formed as a capillary tube into which a working fluid is injected and includes a heat absorption unit coupled to the other surface of the PCB 100 to transfer heat and a heat dissipation unit discharging the heat absorbed by the heat absorption unit.

In this case, as shown in FIGS. 2 to 4, a part of the heat pipe loop 410, which is coupled to the other surface of the PCB 100, may be the heat absorption unit that receives heat from the other surface of the PCB 100. In addition, an outer side portion of the heat pipe loop 410, which is separated from the other surface of the PCB 100, may be the heat dissipation unit.

In particular, the heat pipe loop 410 of the present exemplary embodiment is formed as the heat pipe of the oscillating capillary tube type using a fluid dynamic pressure, so as to radiate a large amount of heat rapidly. Also, since the heat pipe having the capillary tube structure has light weight, the LED lighting apparatus 1000 according to the present exemplary embodiment may be structurally stabilized.

The oscillating capillary tube type heat pipe has a structure of sealing an inside of the capillary tube against outside after injecting the working fluid and pores into the capillary tube at a predetermined ratio. Accordingly, the oscillating capillary tube type heat pipe has a heat transfer cycle of transporting a large amount of heat as a latent heat by using volume expansion and condensation of the pores and the working fluid.

When it comes to the heat transfer mechanism, in the heat absorption unit that absorbs the heat, nucleate boiling occurs as much as the absorbed heat, and thus, the pores existing in the heat absorption unit expand in a volume thereof. Here, since the capillary tube maintains a constant internal volume, the pores existing in the heat dissipation unit that dissipates the heat are contracted as much as the expanded volume of the pores existing in the heat absorption unit.

Therefore, when pressure balancing state in the capillary tube collapses, floating including vibration of the working fluid and the pores occurs in the capillary tube, and accordingly, the latent heat is transported due to temperature rising caused by variation in the volume of the pores, and the heat dissipation is performed.

Here, the oscillating capillary tube type heat pipe may include the capillary tubes formed of a metal material having a high thermal conductivity such as copper or aluminium. Accordingly, the heat pipe may receive the heat transfer rapidly and may rapidly cause the variation in the volume of the pores injected therein.

As described above, in the LED lighting apparatus 1000 according to the present exemplary embodiment, the heat sink 400 includes the heat pipe loop 410 so as to dissipate the heat more efficiently.

The power unit 500 is a unit for supplying electric power to the LED chip 200, and may include a power supply device such as a switching mode power supply (SMPS) that may be applied to the LED lighting apparatus 1000.

Here, the heat pipe loop 410 has a spiral structure and is disposed as a loop so as to form the heat dissipation unit of a radial shape, and the power unit 500 may be provided to be inserted to a center region of the heat pipe loop 410.

In particular, as shown in FIGS. 2 to 4, the heat pipe loop 410 is formed by continuously connecting unit loops and may be formed to have the spiral structure. As such, the spiral structure in which the capillary tube is wound with a dense interval may make the long capillary tube arranged effectively in a restricted area.

Moreover, the heat pipe loop 410 of the present exemplary embodiment may be disposed as a loop type so that opposite ends of the heat pipe loop 410 may face each other. Accordingly, the heat pipe loop 410 may have a radial shape having an empty center region, and thus, the heat pipe loop 410 may have an excellent air permeability and have an excellent heat dissipation performance regardless of an orientation in which the heat pipe loop 410 is provided.

In this case, the heat pipe loop 410 may have both an open loop structure and a closed loop structure. Also, if a plurality of heat pipe loops 410 are provided, all or some of the heat pipe loops 410 may be connected to other neighboring heat pipe loops 410. Accordingly, the plurality of heat pipe loops 410 may have entirely an open loop shape or a closed loop shape, according to a design necessity.

Also, in the present exemplary embodiment, the heat pipe loop 410 having the spiral structure, in which the unit loops are connected continuously, is shown as an example, but one or more exemplary embodiments are not limited thereto. That is, the heat pipe loop 410 may have various loop shapes, for example, a shape in which unit loops formed separately are arranged sequentially.

In addition, as shown in FIGS. 2 to 4, the power unit 500 is configured to be inserted into the empty center region of the heat pipe loop 410, so that the heat generated by the power unit 500 may be dissipated to some degree. In addition, a structure and a specification of the LED lighting apparatus 1000 according to the present exemplary embodiment may be relatively simplified.

In the LED lighting apparatus 1000 according to the present exemplary embodiment, a continuous insertion recess 110 corresponding the shape of the heat absorption unit is formed in the other surface of the PCB 100, and the heat pipe loop 410 may be coupled to the PCB 100 when the heat absorption unit is inserted in the insertion recess 110.

In this case, the continuous insertion recess 110 denotes that the insertion recess 110 is formed to extend to a predetermined length or longer along with the outer surface of the PCB 100, as shown in FIG. 4.

As described above, if the heat pipe loop 410 is directly coupled to the other surface of the PCB 100, an attaching strength may degrade or an isolation between the PCB 100 and the heat pipe loop 410 may occur during assembling or using the LED lighting apparatus 1000.

Therefore, the insertion recess 110 as shown in FIGS. 2 to 4 is formed in the other surface of the PCB 100 and the heat absorption unit of the heat pipe loop 410 is inserted in the insertion recess 110 to be engaged, and accordingly, the attaching strength may be improved and the isolation may be prevented.

Meanwhile, the insertion recess 110 may be modified variously, for example, the insertion recess 110 may be formed in a part or an entire part of the other surface of the PCB 100, if necessary.

In the LED lighting apparatus 1000 according to the present exemplary embodiment, the PCB 100 and the heat pipe loop 410 may be coupled to each other by using a thermal conductive adhesive. In this case, the PCB 100 and the heat pipe loop 410 may be formed of different materials from each other.

If the PCB 100 and the heat pipe loop 410 are formed of the different materials from each other, the adhesive may be preferably used to couple the PCB 100 and the heat pipe loop 410 to each other. However, if a general adhesive is used, the thermal conductive performance may be degraded.

Therefore, the thermal conductive adhesive having excellent thermal conductivity may be used to couple the PCB 100 and the heat pipe loop 410 to each other, and thus, the degradation of the heat dissipation performance may be prevented.

Also, in the LED lighting apparatus 1000 according to the present exemplary embodiment, the PCB 100 and the heat pipe loop 410 may be coupled to each other by a soldering method. In this case, the PCB 100 and the heat pipe loop 410 may be formed of a metal material.

If the PCB 100 and the heat pipe loop 410 are formed of the metal material, the soldering method rather than the adhesive may show higher attaching strength. Also, the soldering method may be an effective coupling method in that there is no specific inclusion that may degrade the thermal conductivity according to the soldering method.

In the LED lighting apparatus 1000 according to the present exemplary embodiment, the ventilation unit 300 may include an air circulator 310 that accelerates flowing of the air induced through an air passage. A velocity of the air circulating in the LED lighting apparatus 1000 may be adjusted by the air circulator 310.

In this case, the air circulator 310 may include a device that may inhale or exhale the air via wings, for example, a fan.

Therefore, if the heat dissipation performance is not sufficient enough with the air circulation through the natural circulation, the heat dissipation performance of the LED lighting apparatus 1000 may be improved by generating a forced circulation.

A cover member 600 may protect internal elements and may generate an effective flow of the air. The cover member 600 may be formed of a transparent material so as to transmit light, and may be coupled to a base 800 to cover the internal elements and may include an air flowing hole corresponding to the location of the opening.

The cover member 600 is formed to surround a side surface and a lower portion of the LED lighting apparatus 1000 in order to cover the internal elements, and thus, may protect the internal elements of the LED lighting apparatus 100 against external shock and contamination.

The base 800 is formed to surround the side surface and an upper portion of the LED lighting apparatus 1000, and may be coupled to the cover member 600. A ventilation hole, through which the air induced through the air flow passage of the ventilation unit 300 may be discharged, may be formed in the base 800. The base 800 may be formed of an insulating material such as synthetic resin.

An electric connection unit 700 that is electrically connected to the LED chip 200 via the power unit 500 may be coupled to an end portion of the base 800, and the base 800 may have a hemisphere structure, in which a space unit is formed therein. Here, the electric connection unit 700 may have an Edison type socket or a swan type socket.

Since the ventilation holes are formed in every direction on a spherical surface of the base 800, the air flowing laterally around the base 800 may pass through the base 800 and the heat dissipation performance may be improved.

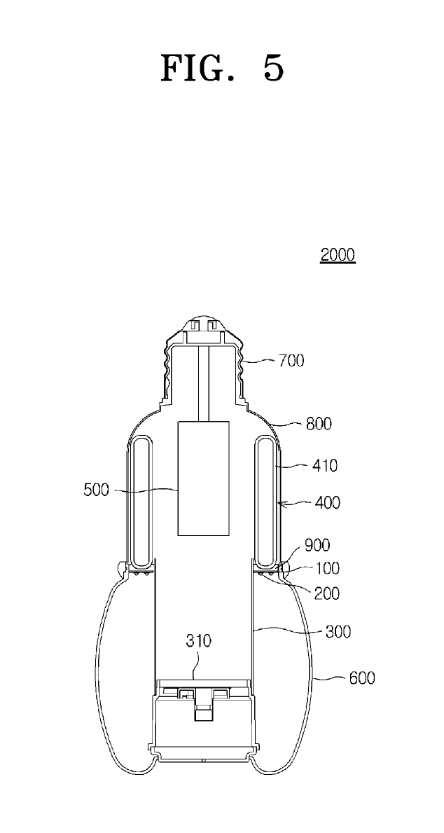

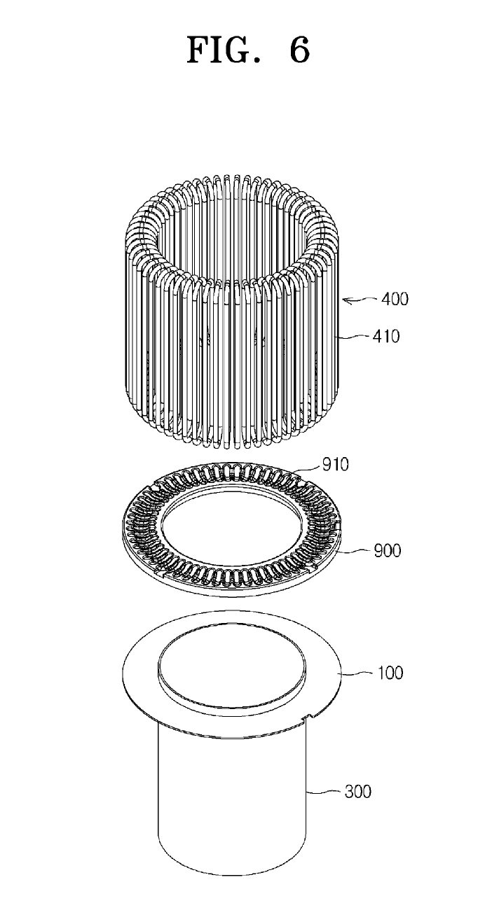

FIG. 5 is a cross-sectional view of an LED lighting apparatus according to another exemplary embodiment of the inventive concept. FIG. 6 is a diagram showing in detail a PCB, a ventilation unit, a thermal base, and a heat sink in the LED lighting apparatus according to another exemplary embodiment of the inventive concept.

As shown in FIGS. 5 and 6, the LED lighting apparatus 2000 according to another exemplary embodiment of the inventive concept further includes the thermal base 900, when it is compared with the LED lighting apparatus 1000 according to the exemplary embodiment of the inventive concept.

The thermal base 900 is formed as a plate type disposed between the PCB 100 and the heat sink 400, and may be an auxiliary member for further stabilizing the coupling between the PCB 100 and the heat sink 400.

In this case, the thermal base 900 includes intermittent insertion grooves 910 corresponding to the shape of the heat absorption unit in a surface coupled to the heat sink 400, and the heat pipe loop 410 may be coupled to the thermal base 900 when the heat absorption unit is inserted in the insertion grooves 910.

Here, the intermittent insertion grooves 910 denote a plurality of insertion grooves 910 that are separately formed along the surface of the thermal base 900 without being connected to one another, as shown in FIG. 6.

Therefore, each heat absorption unit is inserted into each of the insertion grooves 910, which corresponds thereto, so as to improve an attaching strength further and to prevent an isolation, and accordingly, the location of the heat absorption unit may be stably fixed.

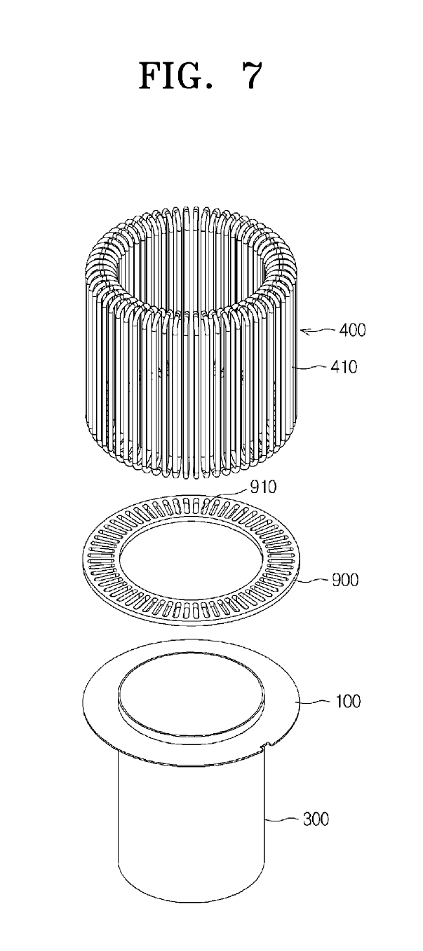

FIG. 7 is a diagram showing a modified example of the thermal base in detail in an LED lighting apparatus according to another exemplary embodiment of the inventive concept.

As shown in FIG. 7, in the LED lighting apparatus 2000 according to the present exemplary embodiment, the thermal base 900 includes intermittent through holes 920 penetrating through opposite surfaces of the thermal base 900 to correspond to the shape of the heat absorption unit, and the heat pipe loop 410 may be coupled to the thermal base 900 when the heat absorption unit is inserted into the through holes 920 to contact the PCB 100.

As descried above, when the heat absorption unit is inserted into the insertion grooves 910, the heat transferring path is relatively more complicated and the heat dissipation efficiency may degrade because the heat generated from the LED chip 200 is transferred to the heat sink 400 after passing through the PCB 100 and the thermal base 900.

Therefore, if the each heat absorption unit is inserted into the through hole 920 corresponding thereto and is coupled to the thermal base 900 while contacting the PCB 100, some of the heat generated from the LED chip 200 may be directly transferred to the heat sink 400 from the PCB 100 without passing through the thermal base 900.

Accordingly, the location of the heat absorption unit may be fixed more stably, and degradation of the heat dissipation efficiency may be prevented appropriately.

In the LED lighting apparatus 2000 according to the present exemplary embodiment, the PCB 400 and the heat pipe loop 410 or the thermal base 900 and the heat pipe loop 410 may be coupled to each other by using an adhesive or by a soldering method.

Meanwhile, the other elements except for the above-described elements in the LED lighting apparatus 2000 are the same as or similar to those of the LED lighting apparatus 1000 according to the exemplary embodiment of the inventive concept, and thus, detailed descriptions about the same elements are omitted.

While the inventive concept has been particularly shown and described with reference to exemplary embodiments thereof, it will be understood by those of ordinary skill in the art that various changes in form and details may be made therein without departing from the spirit and scope as defined by the following claims.

### INDUSTRIAL APPLICABILITY

According to an aspect of the inventive concept, a light emitting diode (LED) chip is mounted on a surface of a printed circuit board (PCB) and a heat sink is coupled to the other surface of the PCB, and air may flow through a ventilation unit so that an LED light emitting apparatus may have an excellent heat dissipating performance with a simple structure.

1. A light emitting diode (LED) lighting apparatus, comprising:
a printed circuit board (PCB) having a plate-shaped structure with an opened center portion;
an LED chip mounted on a surface of the PCB;
a ventilation unit comprising an end portion having an opening, other end portion coupled to the opened center portion of the PCB, and an air flowing passage connecting the opening and the opened center region of the PCB to each other;
a heat sink coupled to other surface of the PCB so as to cool down heat generated from the LED chip;
a cover member comprising an air flowing hole corresponding to a location of the opening and covering partially the PCB, the LED chip, the ventilation unit, and the heat sink; and
a base comprising a ventilation hole that is capable of connecting to the air flowing path and coupled to the cover ember so as to cover remaining parts of the PCB, the LED chip, the ventilation unit, and the heat sink.

2. The LED lighting apparatus of claim 1, wherein the heat sink comprises a heat pipe loop of an oscillating capillary tube type, the heat pipe loop being formed as capillary tubes into which a working fluid is injected and comprising a heat absorption unit coupled to the other surface of the PCB to transfer heat and a heat dissipation unit configured to discharge the heat absorbed by the heat absorption unit.

3. The LED lighting apparatus of claim 2, further comprising a power unit for supplying electric power to the LED chip,
wherein the heat pipe loop has a spiral structure and is disposed in a loop shape so as to form the heat dissipation unit of a radial shape, and the power unit is inserted in a center region of the heat pipe loop.

4. The LED lighting apparatus of claim 2, wherein a continuous insertion recess corresponding to a shape of the heat absorption unit is formed in the other surface of the PCB, and the heat pipe loop is coupled to the PCB by inserting the heat absorption unit in the insertion recess.

5. The LED lighting apparatus of claim 2, further comprising a thermal base having a plate-shaped structure and disposed between the PCB and the heat sink, wherein the thermal base comprises intermittent insertion grooves corresponding to the shape of the heat absorption unit in a surface coupled to the heat sink, and the heat pipe loop is coupled to the thermal base by inserting the heat absorption unit into the insertion grooves.

6. The LED lighting apparatus of claim 2, further comprising a thermal base having a plate-shaped structure and disposed between the PCB and the heat sink, wherein the thermal base comprises intermittent through holes penetrating through opposite surfaces thereof to correspond to the shape of the heat absorption unit, and the heat pipe loop is coupled to the thermal base by inserting the heat absorption unit into the through holes to contact the PCB.

7. The LED lighting apparatus of claim 4 wherein the PCB and the heat pipe loop or the thermal base and the heat pipe loop are coupled to each other by using a thermal conductive adhesive.

8. The LED lighting apparatus of claim 4 wherein the PCB and the heat pipe loop or the thermal base and the heat pipe loop are coupled to each other by a soldering method.

9. The LED lighting apparatus of claim 4 wherein the ventilation unit comprises an air circulator configured to accelerate flowing of air induced through the air flowing passage.

10. The LED lighting apparatus of claim 5 wherein the PCB and the heat pipe loop or the thermal base and the heat pipe loop are coupled to each other by using a thermal conductive adhesive.

11. The LED lighting apparatus of claim 6 wherein the PCB and the heat pipe loop or the thermal base and the heat pipe loop are coupled to each other by using a thermal conductive adhesive.

12. The LED lighting apparatus of claim 5 wherein the PCB and the heat pipe loop or the thermal base and the heat pipe loop are coupled to each other by a soldering.

13. The LED lighting apparatus of claim 6 wherein the PCB and the heat pipe loop or the thermal base and the heat pipe loop are coupled to each other by a soldering.

14. The LED lighting apparatus of claim 5 wherein the ventilation unit comprises an air circulator configured to accelerate flowing of air induced through the air flowing passage.

15. The LED lighting apparatus of claim 6 wherein the ventilation unit comprises an air circulator configured to accelerate flowing of air induced through the air flowing passage.
